(19) United States
(12) Patent Application Publication
(10) Pub. No.: US 2016/0001232 A1
(43) Pub. Date: Jan. 7, 2016

(54) NANOFABRICATION OF NANOPOROUS ARRAYS

(71) Applicants: LAWRENCE LIVERMORE NATIONAL SECURITY, LLC, Livermore, CA (US); ETH ZURICH, Zurich (CH)

(72) Inventors: Tiziana C. Bond, Livermore, CA (US); Hyung Gyu Park, Zurich (CH); Ali O. Altun, Zurich (CH)

(21) Appl. No.: 14/755,403

(22) Filed: Jun. 30, 2015

Related U.S. Application Data
(60) Provisional application No. 62/020,259, filed on Jul. 2, 2014.

(51) Int. Cl. B01D 67/00; H01M 4/02; H01M 4/04

(52) U.S. Cl. CPC B01D 67/0062; H01M 4/0404; H01M 4/02; H01M 2004/021

(57) ABSTRACT

An array having nanopores is produced by coating a thin layer of metal or other material onto a substrate and creating a mask on the metal or other material by combining a first polymer and a second polymer. The first polymer self-assembles into nanodomains of the first polymer in the second polymer resulting in the formation of a uniform hexagonal pattern of the first polymer nanodomains in the second polymer over the entire surface of the metal or other material. The nanodomains are removed by etching to form nano-voids that extend through the polymer layer. Nanopores are created in the metal or other material layer by ion beam milling the metal through the nano-voids to produce nano-pores that extend through the metal or other material creating an array having nanopores.

### CROSS-REFERENCE TO RELATED APPLICATIONS

This application claims priority to and benefit under 35 U.S.C. §119(e) of U.S. Provisional Patent Application No. 62/020,259 filed Jul. 2, 2014 entitled “High Fidelity Macroscale Coverage of Nanoporous Metal Arrays Via Lift-Off-Free Nanofabriaction,” the content of which is hereby incorporated by reference in its entirety for all purposes.

### STATEMENT AS TO RIGHTS TO APPLICATIONS MADE UNDER FEDERALLY SPONSORED RESEARCH AND DEVELOPMENT

The United States Government has rights in this application pursuant to Contract No. DE-AC52-07NA27344 between the United States Department of Energy and Lawrence Livermore National Security, LLC for the operation of Lawrence Livermore National Laboratory.

### BACKGROUND

1. Field of Endeavor

The present application relates to nanolithography and more particularly to nanolithography for creating nanoporous arrays.

2. State of Technology

This section provides background information related to the present disclosure which is not necessarily prior art.

United States Published Patent Application No. 2013/0245416 for a nanoporous metal multiple electrode array and method of making same provides the following state of technology information. A method is disclosed for fabricating a low-impedance nanoporous metal multiple electrode array for measuring electrophysiology activity. A patterned photoresist is applied to a substrate, in which the patterned photoresist corresponds to a pattern of the nanoporous metal multiple electrode array. A metal alloy including a sacrificial alloying element is deposited in the pattern of the nanoporous metal electrode array. The patterned photoresist is removed to expose the metal alloy as deposited. At least part of the sacrificial alloying element is removed from the metal alloy to create nanoporous metal electrode tips thereby forming the nanoporous metal multiple electrode array. The resultant nanoporous metal multiple electrode array has improved impedance characteristics in comparison to conventional multiple electrode arrays.

U.S. Pat. No. 8,512,588 for a method of fabricating a scalable nanoporous membrane filter provides the following state of technology information. A method of fabricating a nanoporous membrane filter having a uniform array of nanopores etch-formed in a thin film structure (e.g. (100)-oriented single crystal silicon) having a predetermined thickness, by (a) using interferometric lithography to create an etch pattern comprising a plurality array of unit patterns having a predetermined width/diameter, (b) using the etch pattern to etch frustum-shaped cavities or pits in the thin film structure such that the dimension of the frustum floors of the cavities are substantially equal to a desired pore size based on the predetermined thickness of the thin film structure and the predetermined width/diameter of the unit patterns, and (c) removing the frustum floors at a boundary plane of the thin film structure to expose, open, and thereby create the nanopores substantially having the desired pore size.

United States Published Patent Application No. 2005/0255581 for self-organized nanopore arrays with controlled symmetry and order provides the following state of technology information. An ordered, single domain nanopore array having a macroscale area in a first material is provided. A method of making a nanopore arrays with a controlled pattern include providing a substrate comprising a first surface having a first pattern, depositing a first material capable of forming nanopores onto said first-surface having the first pattern, and anodically oxidizing said first material to form the nanopore array with the controlled pattern in the anodically oxidized first material.

U.S. Pat. No. 8,786,852 for nanoscale array structures suitable for surface enhanced Raman scattering and methods related thereto provides the following state of technology information. Methods for fabricating nanoscale array structures suitable for surface enhanced Raman scattering, structures thus obtained, and methods to characterize the nanoscale array structures suitable for surface enhanced Raman scattering. Nanoscale array structures may comprise nanotrees, nanorecesses and tapered nanopillars.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

Posing superior properties, nanoporous metals have been drawing attractions in a wide range of applications. For example, they possess a much higher surface area suitable for better electron transfer which can lead to an improved performance of an electrode in an electric double layer capacitor or a battery or a photovoltaic cell. They offer an increased number of available sites for the adsorption of analytes, typically a highly desirable feature for sensors. At certain wavelengths, they can facilitate an anomalous enhancement of the transmitted light through the tunneling of surface plasmons, a feature widely exploitable by light emitting devices, plasmonic lithography, refractive-index-based sensing, and all-optical switching. Furthermore, low molecular detection limits can be obtained by surface enhanced Raman spectroscopy (SERS) via intense electromagnetic field concentration at hot spots that these nanoporous metals provide.

The inventor's apparatus, systems, and methods provide the production of an array having nanopores. A substrate of silicon or other materials is provided. The substrate has a flat surface. A thin layer of metal or other material is applied to the flat surface of the substrate in a manner that provides a uniform flat surface on the metal or other material. A mask is created on the uniform flat surface of the metal or other material by combining a first polymer and a second polymer to form a polymer layer of the first and second polymer. The first polymer self-assembles into nanodomains of the first polymer in the second polymer. The self-assembly of the nanodomains results in the formation of a uniform hexagonal pattern of the first polymer nanodomains in the second polymer over the entire uniform flat surface on the metal or other material. The nanodomains are removed by etching to form nano-voids that extend through the polymer layer. Nanopores are created in the metal or other material by ion beam milling the metal through the nano-voids to produce nano-pores that extend through the metal or other material creating the array having nanopores.

The inventor's array having nanopores has use in batteries, ultracapacitors, other electrical devices, and any device that utilizes an array with nanopores. The inventor's array having nanopores possess a much higher surface area suitable for better electron transfer providing improved performance of an electrode in an electric double layer capacitor or a battery or a photovoltaic cell.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serve to explain the principles of the apparatus, systems, and methods.

FIG. 1 is a flow chart that illustrates the inventor's nanolithography method for creating an array on a film of metal or other material.

FIG. 2 illustrates additional details of the step of providing a substrate.

FIG. 3 illustrates additional details of the step of coating metal or other material on the surface of the substrate.

FIGS. 4A and 4B illustrate additional details of the step of coating a polymer layer on the surface of the metal or other material described in greater detail.

FIGS. 5A and 5B illustrate the coating of a polymer layer on the metal or other material layer by combining a first polymer and a second polymer that form self-assembled nanodomains of the first polymer in the second polymer.

FIGS. 6A and 6B illustrate removal of the nanodomains by etching leaving nanovoids in the polymer layer.

FIG. 7 illustrates ion beam milling the metal or other material layer through the nanovoids in the polymer layer mask.

FIGS. 8A and 8B illustrate removal of the polymer layer mask leaving the nanoporous array.

FIG. 9 is an illustration of the inventor's nanolithography method for producing a nanoporous array.

FIG. 10 illustrates a nanolithography method for producing a nanoporous array battery.

FIGS. 11A and 11B illustrate nanolithography methods for producing nanoporous filters.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

There exist various methods of creating random nanoporous metal over a large area such as de-alloying, electrochemical deposition, and organic patterning. An ordered array of nanopores, on the other hand, could be directly patterned on a metal thin film by using focused ion beam (FIB) lithography if a tiny area is sufficient. Coverage of a large metal area with an array of nanopores, however, requires a lengthy procedure generally including lithography followed by lift-off. The lift-off process can be a real challenge, particularly when the density of the array is very high. Retention or total peel-off can, for example, occur when the side walls of a sacrificial nanospacer are excessively coated. Reproducibility and uniformity of lift-off can thus be problematic when the pitch size goes below 40-50 nm. Therefore, a lift-off-free technique has been desired in order to produce a highly dense, nanoporous metal array.

Realizing uniform and wafer-scale coverage of ultradense arrays of nanopores on metal thin films is still a big challenge with the current nanomanufacturing methods. The inventors in one or more of their research projects have established a low-cost, high-throughput, lift-off-free nanolithographic method for creating hexagonal arrays of sub-30-nm-sized pores on a metal film, achieving uniform coverage over an entire wafer of 10 cm in diameter. Spherical nanodomains of poly(methyl methacrylate) (PMMA) were demonstrated to be well-controlled and self-aligned within a polystyrene (PS) matrix layer on a metal thin film without any intermediary coating. After removal of PMMA, the porous PS thin film acts as an etch mask for defining nanoscale pores in the metal underlayer by argon ion beam milling, resulting in wafer-scale patterning with great fidelity. Conditions for such uniformity control of the nanopore arrays critically depend on the initial roughness of the metal layer, from which the best parametric conditions are deduced.

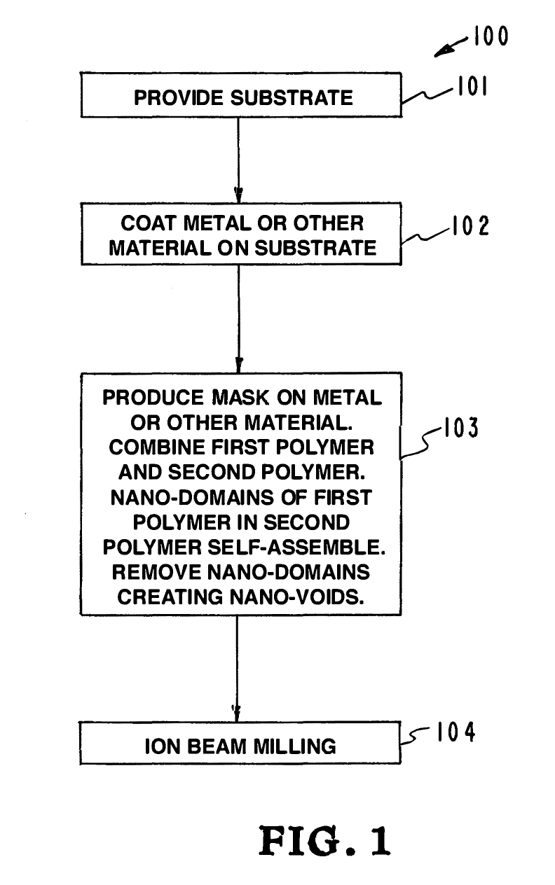

Referring now to the drawings and in particular to FIG. 1, a flow chart illustrates the inventor's nanolithography method for creating an array on a film of metal or other material. The flowchart is designated generally by the reference numeral 100. The inventor's nanolithography method for creating an array on a film of metal or other material provides the production of an array having nanopores.

As illustrated in FIG. 1, the nanolithography method for creating an array 100 includes the steps described below

Step 1—Providing a substrate having surface. A substrate of silicon or other materials is provided. The substrate has a flat surface. The step 1 of providing a substrate having surface is designated by the reference numeral 101.

Step 2—Coating metal or other material on the surface of the substrate. A thin layer of metal or other material is applied to the flat surface of the substrate in a manner that provides a uniform flat surface on the metal or other material. This provides an exposed surface of the metal or other material for additional processing. The step 2 coating of metal or other material on the surface of the substrate is designated by the reference numeral 102.

Step 3—Forming a mask on the exposed metal or other material surface by combining a first polymer and a second polymer to form self-assembled nanodomains of the first polymer in the second polymer and removing the nanodomains to form nano-voids in the mask. A mask is created on the uniform flat surface of the metal or other material by combining a first polymer and a second polymer to form a polymer layer of the first and second polymer. The first polymer self-assembles into nanodomains of the first polymer in the second polymer. The self-assembly of the nanodomains results in the formation of a uniform hexagonal pattern of the first polymer nanodomains in the second polymer over the entire uniform flat surface on the metal or other material. The nanodomains are removed by etching to form nano-voids that extend through the polymer layer. The step 3 of forming a mask is designated by the reference numeral 103.

Step 4—Ion beam milling the metal or other material through the nano-voids of the mask producing nano-pores in the metal or other material creating the array. Nanopores are created in the metal or other material by ion beam milling the metal through the nano-voids to produce nano-pores that extend through the metal or other material creating the array having nanopores. The step 4 of ion beam milling is designated by the reference numeral 104.

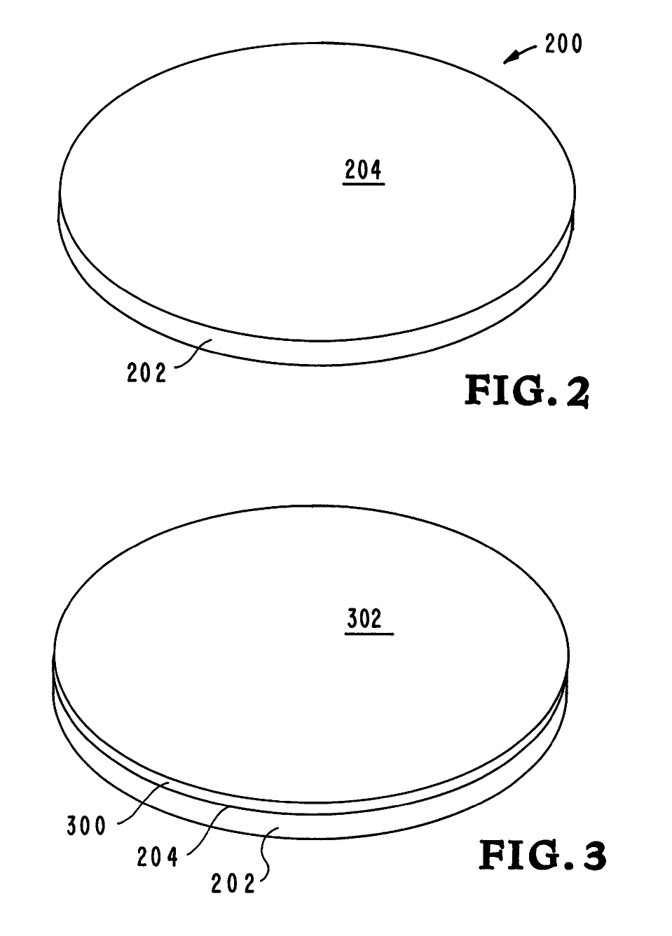

Referring now to FIG. 2 the step of providing a substrate is illustrated in greater detail. The overall illustration of providing a substrate is designated generally by the reference numeral 200. A substrate 202 of silicon or other material is provided. The substrate 202 has a flat surface 204.

In one embodiment the inventors used a 10 centimeter diameter silicon wafer as the substrate 202; however it is to be understood that other size silicon wafers and substrates of other materials can be used as the substrate 202. For example, substrates of silicon dioxide, aluminum oxide, sapphire, germanium, gallium arsenide, polyethylene terephthalate, polyethylene-naphthalate, polyimide, paper, foil can be used as the substrate 202. Substrates are chosen for the end use environment of the finished array. For example if a flexible array is to be produced the material for the substrate is chosen to be flexible.

Referring now to FIG. 3 the step of coating metal or other material on the surface of the substrate is illustrated in greater detail. A thin layer 300 of metal or other material is applied to the flat surface 204 of the substrate 202 in a manner that provides a uniform planar surface 302 on the metal or other material. This provides an exposed surface 302 of the metal or other material for additional processing.

The surface 302 of the metal or other material 300 is smooth. In determining the best roughness of surface 302 the inventors deposited Au on bare Si wafers with various thicknesses from 30 nm to 200 nm in order to obtain various surface roughness values. In a first sample, 30-nm-thick Au was deposited on a 30-nm-thick Pt layer. In additional samples, thicknesses of Au deposited directly on Si were 30, 50, 100, 150 and 200 nm, respectively. Au deposition rate for the first sample was faster than for the other samples. The roughness of the Au thin film generally increases with the film thickness. The additional process still takes place even for a rather rough surface (Rrms>20 Å), but it is actually the pore coverage that is strongly influenced by the metal film roughness. The first sample was the smoothest sample (Rrms of 6.5 Å), the pore coverage was 91.9 (±1.1)%. Surprisingly, a slight variation in Rrms can give rise to considerable degradation in the pore coverage. With increased roughness, uniformity also decreases. Although the inventors had to deposit a thin film to control the surface roughness, they envisioned that it is possible to obtain large pore coverage even for thicker metal films by lowering the surface roughness via optimization of deposition parameters. Strategies to improve the smoothness of as-deposited metal films encompass changing metal deposition rate adjusting the temperature of a destination substrate coating a sticking agent layer prior to deposition, and performing a template-striping method.

In an attempt to assess the quality of the inventors nanoporous metal films, they defined a term, pore coverage, as a ratio between the areal number densities obtained experimentally and theoretically extrapolated for ideal conditions. This pore coverage measures 91.9% for the inventor's nanoporous metal films over a 10-cm-diameter wafer with a great uniformity value of 99%. The inventors characterize that the pore coverage becomes lower as the metal film gets rougher. In order to explain the relationship between pore coverage and roughness, the inventors introduced the effect of rough localities of the metal surface on BCP self-assembly by analyzing how they could impede the mobility of PS molecules thereby creating defect sites on the nanoporous PS and eventually on the nanoporous metal arrays. Finally, the inventors propose a method to estimate an expected pore coverage value for any given metal roughness by taking into account the areal density of the rough localities.

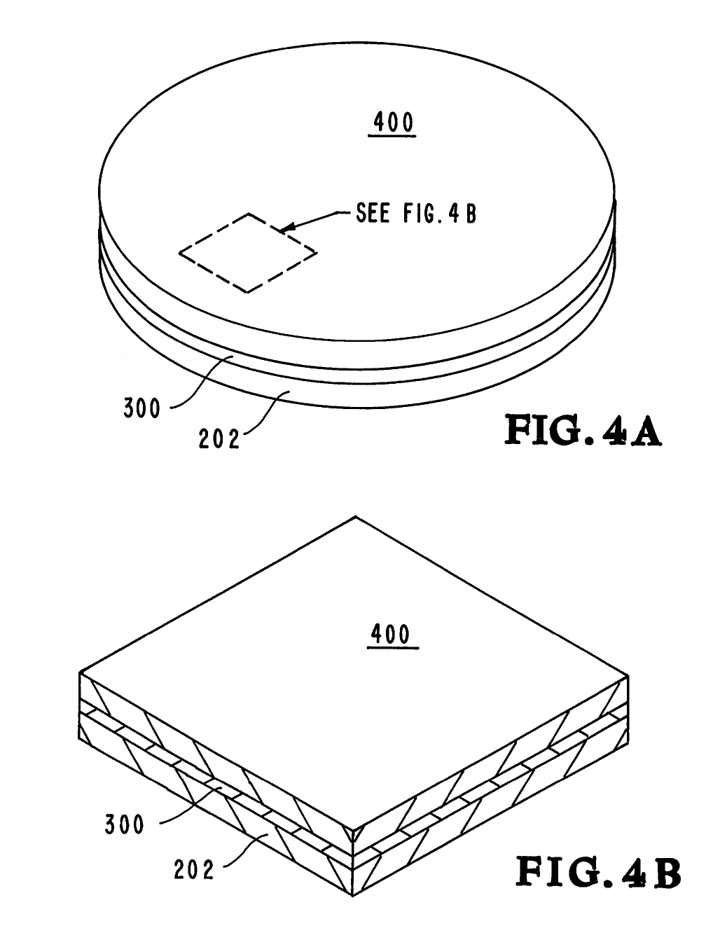

Referring now to FIGS. 4A and 4B the step of coating a polymer layer on the surface of the metal or other material is illustrated in greater detail. As shown in FIG. 4A, a polymer layer 400 is coated on the surface of the metal or other material 300. The polymer layer 400 will be used to create a mask for further processing.

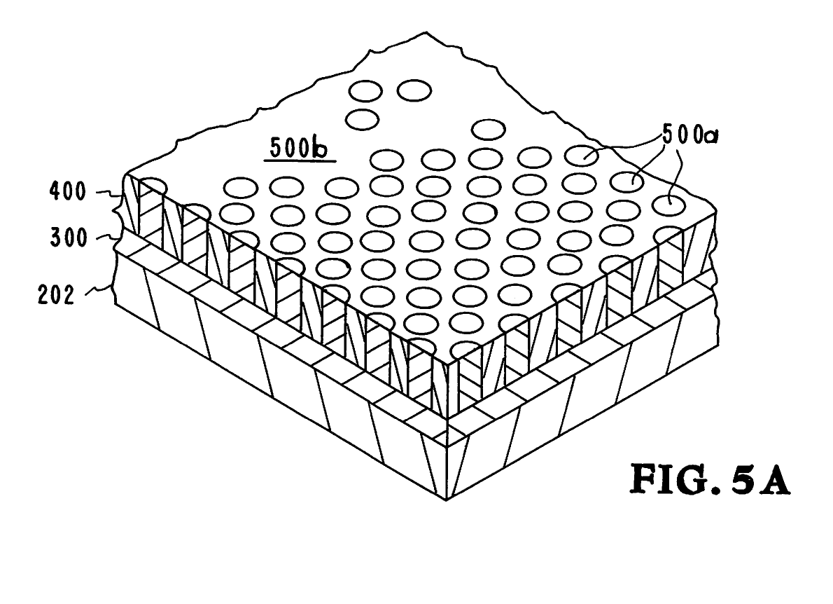

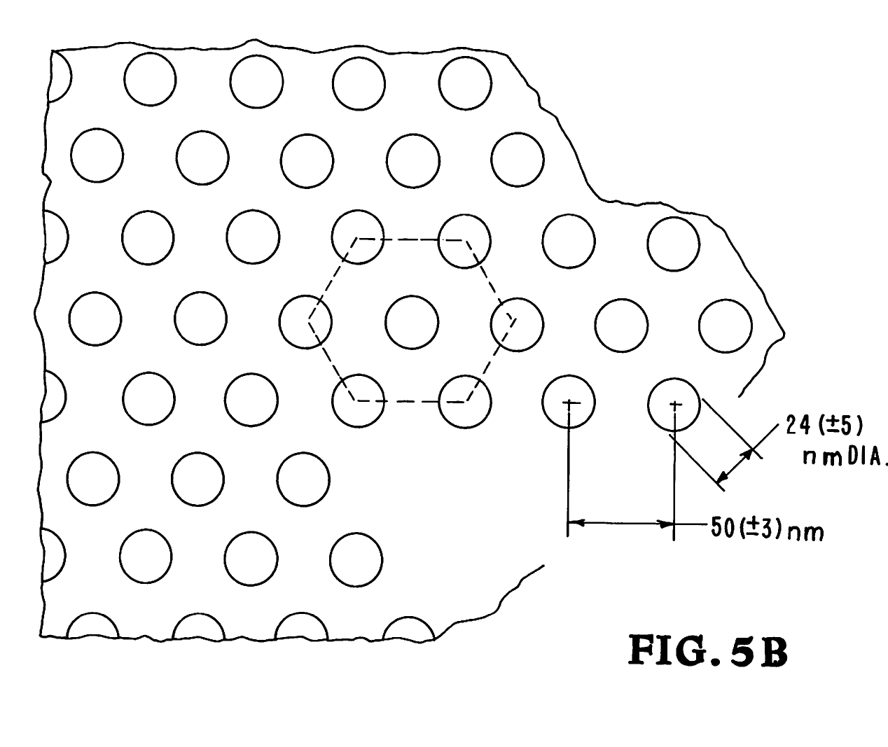

FIG. 4B is a greatly enlarged cut away section of the polymer layer 440, metal or other material layer 300 and substrate 202. The greatly enlarged cut away section will be used in FIGS. 5, 6, 7, and 8 and in the following description of the polymer layer 400 being used to create a mask.

Referring now to FIGS. 5A and 5B the forming a mask on the exposed metal or other material surface by combining a first polymer and a second polymer that form self-assembled nanodomains of the first polymer in the second polymer is illustrated in greater detail. As illustrated in FIG. 5A, the polymer layer 400 has been coated on the metal or other material layer 300. The polymer layer 400 is made of a first polymer 500a and a second polymer 500b.

By selecting the composition of the first polymer 500a and the second polymer 500b and by controlling the application of the polymer layer 400 the inventors have discovered that it is possible to pattern nanodomains of polymer 500a in polymer 500b. The nanodomains are formed directly on the material 300 at macroscales without use of any intermediary. Suitable nanodomains can be formed by lowering the roughness of the destination material 300 and controlling the application of the polymer layer 400 to pattern nanodomains of polymer 500a in polymer 500b. The nanodomains can be in the form of cylindrical, spherical, lamellar blocks, or other shapes of different polymerized monomers. Compared with spherical nanodomains, cylindrical nanodomains have been more useful due to their high aspect ratio and negligible residual layers.

The application of the polymer layer 400 results in the first polymer 500a self-assembling into nanodomains of the first polymer 500a in the second polymer 500b. The self-assembly of the nanodomains results in the formation of a uniform hexagonal pattern of the first polymer nanodomains 500a in the second polymer 500b over the entire uniform planar surface of the metal or other material layer 300 as illustrated in FIG. 5B.

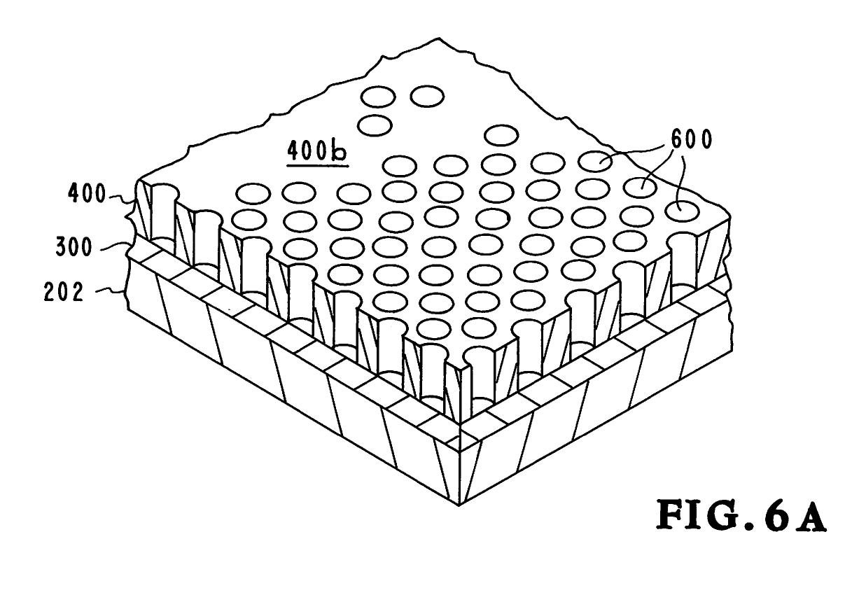

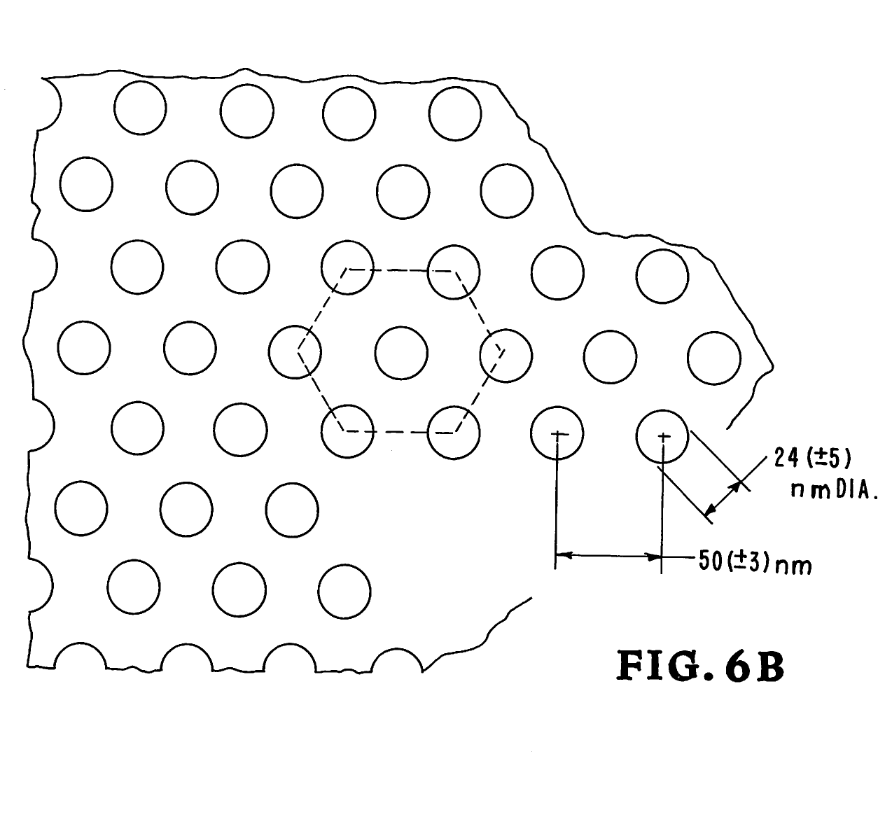

Referring now to FIGS. 6A and 6B the removal of the nanodomains by etching leaving nanovoids in the polymer is illustrated in greater detail. As illustrated in FIG. 6A, a mask is formed by removal of the nanodomains leaving holes 600 that extend through the polymer layer 400b. The nanodomains are removed by etching and nanovoids (holes) 600 are left in the polymer 400b. As illustrated in FIG. 6B, the nanovoids form a uniform hexagonal pattern of holes 600 over the entire polymer layer that extend through the polymer 400b.

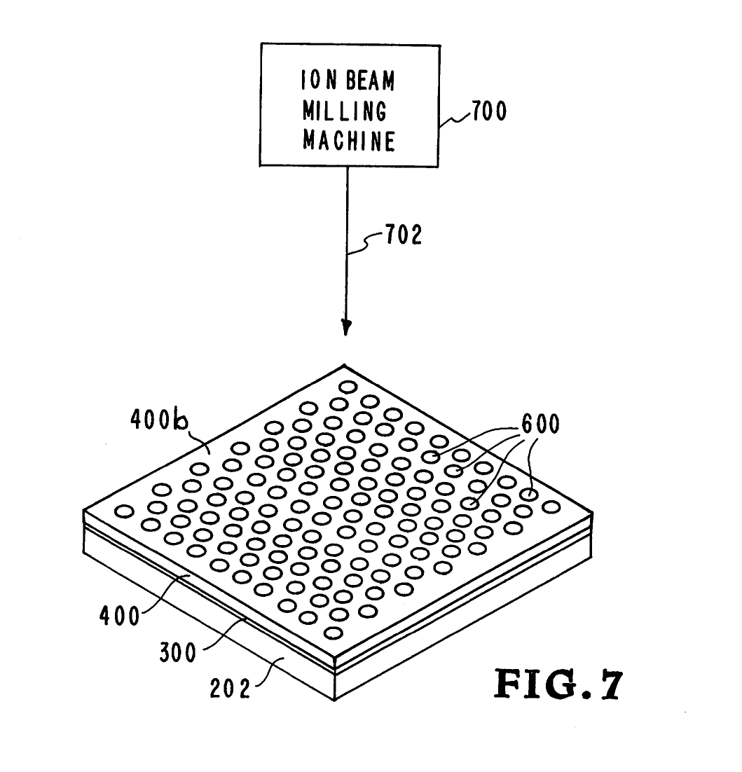

Referring now to FIG. 7, the step of ion beam milling the metal or other material through the nano-voids of the mask producing nano-pores in the metal or other material is illustrated in greater detail. The holes 600 in the polymer layer 400b are used as a mask for ion beam milling the metal or other material layer 300.

As shown in FIG. 7, an ion beam milling machine 700 produces an ion beam 702 that ablates the metal or other material layer 300 exposed by the holes 600 in the mask. The ion beam milling of the metal or other material layer 300 through the holes 600 in the polymer layer 400b produces nano-pores in the metal or other material layer 300 creating the array. When the layer 300 is made of material other than metal, other physical etching techniques can be used to produce the nano-pores and create the array.

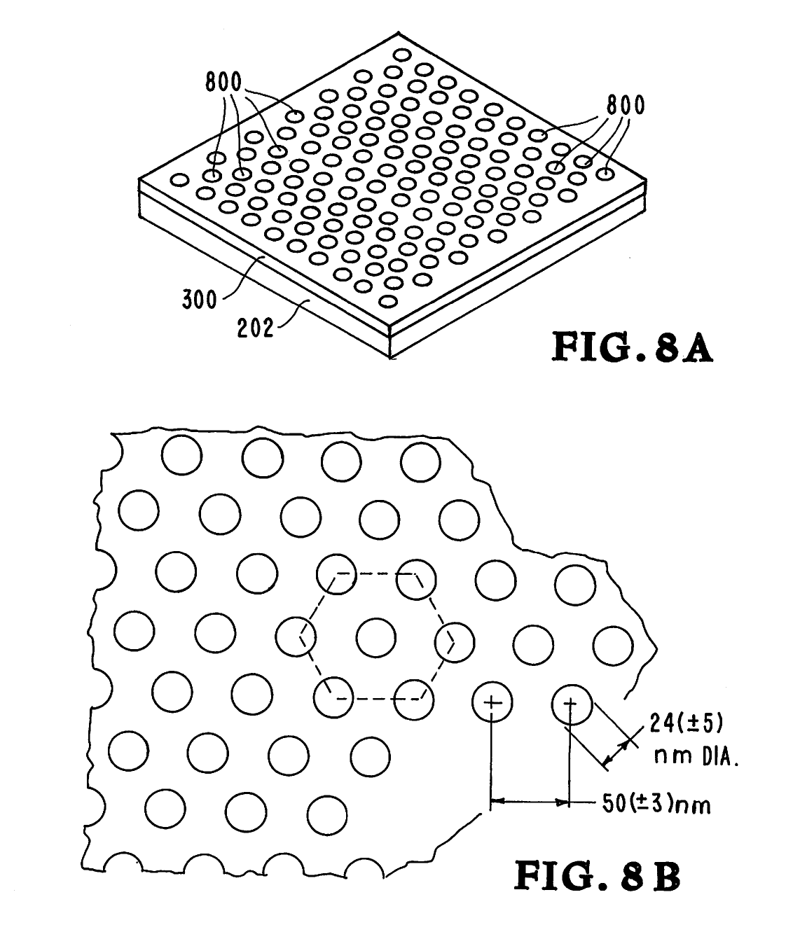

Referring now to FIGS. 8A and 8B, removal of the polymer layer mask leaving the nanoporous array is illustrated in greater detail. As illustrated in FIG. 8A, the polymer layer mask has been removed by dissolution leaving the nanoporous array. The ion beam milling of the metal or other material layer 300 through the holes in the polymer layer has produced nano-pores 800 in the metal or other material layer 300 creating the array. As illustrated in FIG. 8B, a hexagonal pattern of holes 800 is formed in the metal or other material layer 300. The array has use in batteries, ultracapacitors, other electrical devices, and any device that utilizes an array with nanopores.

Nanoporous Array

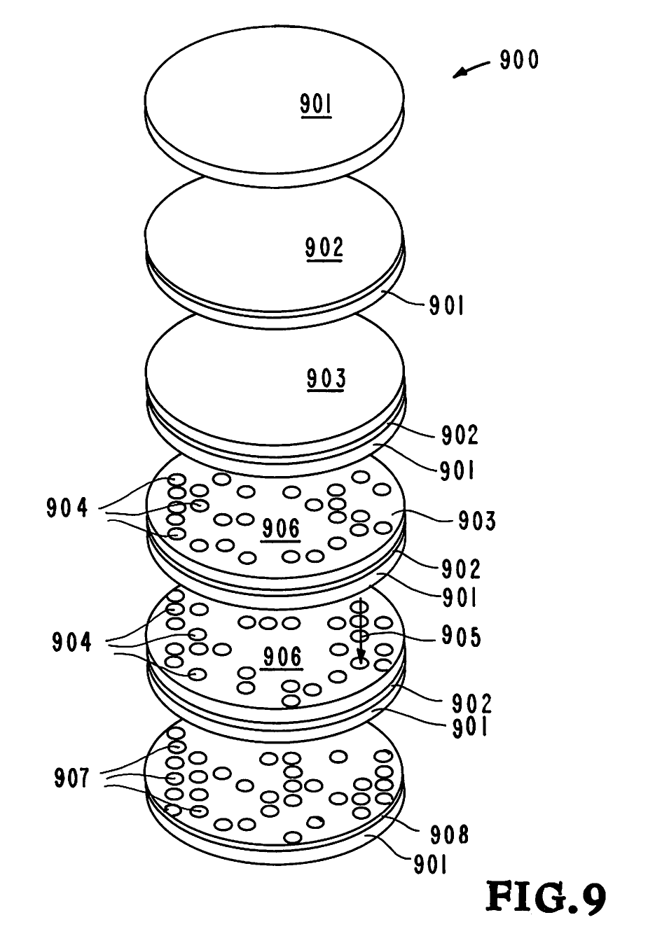

Referring now to FIG. 9, the inventor's nanolithography method for producing a nanoporous array is illustrated. The nanolithography method for producing a nanoporous array is designated generally by the reference numeral 900. The nanoporous array has use in batteries, ultracapacitors, other electrical devices, sensors, and any device that utilizes an array with nanopores. The inventor's array having nanopores possess a much higher surface area suitable for better electron transfer providing improved performance of an electrode in an electric double layer capacitor or a battery or a photovoltaic cell, and for sensing lower analyte concentrations ins sensors in the like of Surface Enhanced Raman or IR.

As illustrated in FIG. 9, the first step is to provide a substrate. The substrate is designated by the reference numeral 901. A substrate of silicon or other material is provided. The substrate 901 has a flat surface. In one embodiment the inventors used a 10 centimeter diameter silicon wafer as the substrate; however it is to be understood that other size silicon wafers and substrates of other materials can be used as the substrate. For example, substrates of silicon dioxide, aluminum oxide, sapphire, germanium, gallium arsenide, polyethylene terephthalate, polyethylene-naphthalate, polyimide, paper, foil can be used as the substrate. Substrates are chosen for the end use environment of the finished array. For example if a flexible array is to be produced the material for the substrate is chosen to be flexible.

The second step illustrated in FIG. 9 is to coat metal or other material on the surface of the substrate 901. A thin layer 902 of metal or other material is applied to the flat surface of the substrate 901 in a manner that provides a uniform planar surface on the metal or other material. This provides an exposed surface of the metal or other material for additional processing.

The surface of the layer metal or other material 902 is smooth. In determining the best roughness of surface 902 the inventors deposited Au on bare Si wafers with various thicknesses from 30 nm to 200 nm in order to obtain various surface roughness values. In a first sample, 30-nm-thick Au was deposited on a 30-nm-thick Pt layer. In additional samples, thicknesses of Au deposited directly on Si were 30, 50, 100, 150 and 200 nm, respectively. Au deposition rate for the first sample was faster than for the other samples. The roughness of the Au thin film generally increases with the film thickness. The additional process still takes place even for a rather rough surface (Rrms>20 Å), but it is actually the pore coverage that is strongly influenced by the metal film roughness. The first sample was the smoothest sample (Rrms of 6.5 Å), the pore coverage was 91.9(±1.1)%. Surprisingly, a slight variation in Rrms can give rise to considerable degradation in the pore coverage. With increased roughness, uniformity also decreases. Although the inventors had to deposit a thin film to control the surface roughness, they envisioned that it is possible to obtain large pore coverage even for thicker metal films by lowering the surface roughness via optimization of deposition parameters. Strategies to improve the smoothness of as-deposited metal films encompass changing metal deposition rate adjusting the temperature of a destination substrate coating a sticking agent layer prior to deposition, and performing a template-striping method. The inventors also use metal other than gold for the nanoporous metal films.

In an attempt to assess the quality of the inventors nanoporous metal films, they defined a term, pore coverage, as a ratio between the areal number densities obtained experimentally and theoretically extrapolated for ideal conditions. This pore coverage measures 91.9% for the inventor's nanoporous metal films over a 10-cm-diameter wafer with a great uniformity value of 99%. The inventors characterize that the pore coverage becomes lower as the metal film gets rougher. In order to explain the relationship between pore coverage and roughness, the inventors introduced the effect of rough localities of the metal surface on BCP self-assembly by analyzing how they could impede the mobility of PS molecules thereby creating defect sites on the nanoporous PS and eventually on the nanoporous metal arrays. Finally, the inventors propose a method to estimate an expected pore coverage value for any given metal roughness by taking into account the areal density of the rough localities.

The third step illustrated in FIG. 9 is the step of coating a polymer layer on the layer 902 of the metal or other material and forming a mask for further processing. As shown, a polymer layer 903 is coated on the surface of the layer 902 metal or other material. The polymer layer 903 will be used to create a mask for further processing.

The polymer layer 903 is used to form a mask by combining a first polymer and a second polymer that form self-assembled nanodomains of the first polymer in the second polymer. By selecting the composition of the first polymer and the second polymer and by controlling the application of the polymer layer the inventors have discovered that it is possible to pattern nanodomains of the first polymer in the second polymer. The application of the polymer layer results in the first polymer self-assembling into nanodomains of the first polymer in the second polymer. The self-assembly of the nanodomains results in the formation of a uniform hexagonal pattern of the first polymer nanodomains in the second polymer over the entire uniform planar surface layer 902 of the metal or other material.

Removal of the nanodomains by etching leaves nanovoid holes 904 in the second polymer. The mask is formed by removal of the nanodomains leaving holes 904 that extend through the polymer layer 903. The nanodomains are removed by etching leaving the nanovoid holes 904 the polymer 903. The nanovoid holes 904 form a uniform hexagonal pattern of holes 904 over the entire polymer layer 903 and the holes 904 extend through the polymer 903.

The fourth step illustrated in FIG. 9 is the step of ion beam milling. In the fourth step the holes 904 in the polymer layer 903 are used as a mask 906 for ion beam milling the metal or other material layer 902. The metal or other material is selectively removed by ion beam milling through the nano-void holes 904 of the mask 906 producing nano-pore holes 904 in the metal or other material layer 902. An ion beam milling machine is used to ablate the metal or other material layer exposed by the holes 904 in the mask 906. This produces nano-pores 907 in the metal or other material layer 902 creating the array.

Nanoporous Array Battery

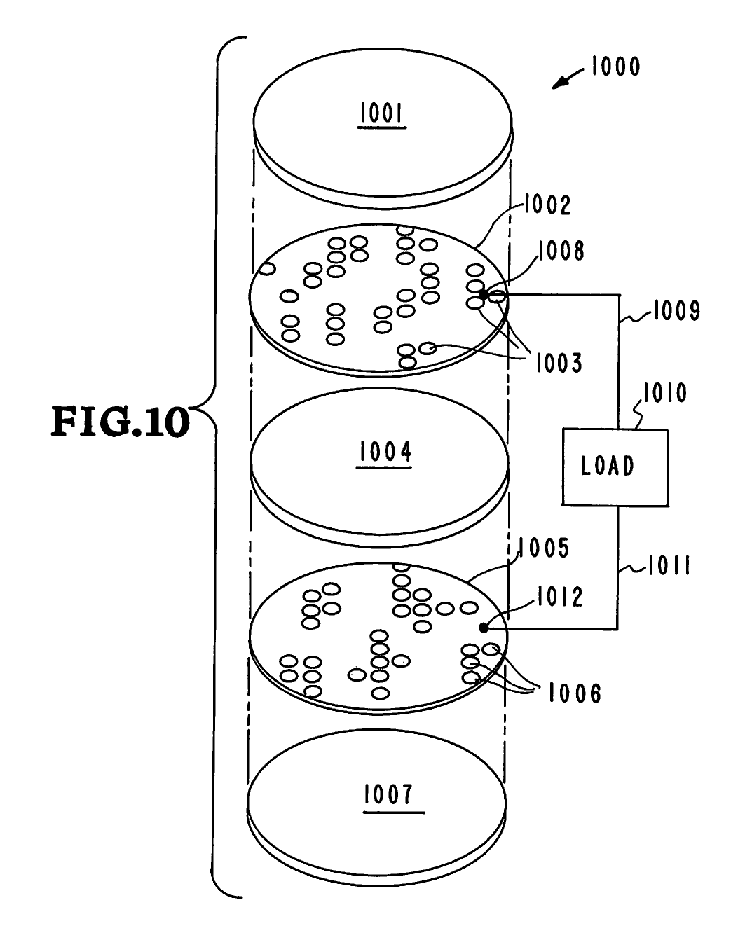

Referring now to FIG. 10, a nanolithography method for producing a nanoporous array battery is illustrated. The nanolithography method for producing a nanoporous array battery is designated generally by the reference numeral 1000.

As illustrated in FIG. 10, substrates 1001 and 1007 are provided. The substrates 1001 and 1007 are made of an insulator material. Metal or other material is coated on the surfaces of substrates 1001 and 1007 to form the battery's anode and cathode.

The battery's anode is produced by applying a thin layer of anode material 1002 to the surface of the substrate 1001. A polymer layer is coated on the layer of anode material 1002 to form a mask for further processing. The polymer layer is used to form a mask by combining a first polymer and a second polymer that form self-assembled nanodomains of the first polymer in the second polymer. Removal of the nanodomains by etching leaves nanovoids in the second polymer. The mask is formed by removal of the nanodomains leaving holes that extend through the polymer layer. The holes are used as a mask for ion beam milling the anode material layer 1002. This produces nano-pores 1003 in the anode material layer 1002. The mask material is removed leaving the battery's anode 1002 that includes the nano-pores 1003. The anode 1002 with nano-pores 1003 possess a much higher surface area and provides better electron transfer and improved performance of the 1000 battery.

The battery's cathode is produced by applying a thin layer of cathode material 1005 to the surface of the substrate 1007. A polymer layer is coated on the layer of cathode material 1005 to form a mask for further processing. The polymer layer is used to form a mask by combining a first polymer and a second polymer that form self-assembled nanodomains of the first polymer in the second polymer. Removal of the nanodomains by etching leaves nanovoids in the second polymer. The mask is formed by removal of the nanodomains leaving holes that extend through the polymer layer. The holes are used as a mask for ion beam milling the cathode material layer 1005. This produces nano-pores 1006 in the cathode material layer 1005. The mask material is removed leaving the battery's cathode 1005 that includes the nano-pores 1006. The cathode 1005 with nano-pores 1006 possess a much higher surface area and provides better electron transfer and improved performance of the 1000 battery.

An electrolyte 1004 is positioned between the battery's anode 1002 and battery's cathode 1005. An electrical lead 1008 is attached to the battery's anode 1002 by connection 1008. An electrical lead 1011 is attached to the battery's cathode 1007 by connection 1012. The electrical lead 1009 and electrical lead 1011 are connected across a load 1010 that is powered by the inventor's battery 1000. In other embodiments of the nanoporous battery 1000, the anode 1002 or the cathode 1005 are made of a standard anode or cathode material.

Photovoltaic Cell

Referring again to FIG. 10, instead of a battery, a photovoltaic cell can be produced by using an active photovoltaic material 1004 instead of the electrolyte material. The substrate 1001 is made of a material that is transparent to light and the electrode 1002 includes nano-pores 1003 making the electrode 1002 transparent to light. This further enhances the light absorption by the active photovoltaic material 1004 by means of the plasmonic enhancement effect, which enhances the electric field of the light within at the edges and surfaces of the pores. In one embodiment the substrate 1001 and the thin layer of material 1002 applied to the surface of the substrate 1001 are made of a material that is transparent to light. In one embodiment, the photovoltaic cell's electrode 1002 is made of a transparent metal oxide to allow light to be absorbed by the active photovoltaic material 1004.

The photovoltaic cell is made by a nanolithography method that includes providing substrates 1001 and 1007. One or both of the substrates 1001 and 1007 are made of made of a material that is transparent to light. Metal or other material is coated on the surfaces of substrates 1001 and 1007 to form the photovoltaic cell's electrodes.

An active photovoltaic material 1004 is positioned between the photovoltaic cell's electrode 1002 and the photovoltaic cell's electrode 1005. An electrical lead 1008 is attached to the photovoltaic cell's electrode 1002 by connection 1008. An electrical lead 1011 is attached to the photovoltaic cell's electrode 1007 by connection 1012. The electrical lead 1008 and electrical lead 1011 are connected across a load 1010 that is powered by the active photovoltaic material 1004.

Nanoporous Filter

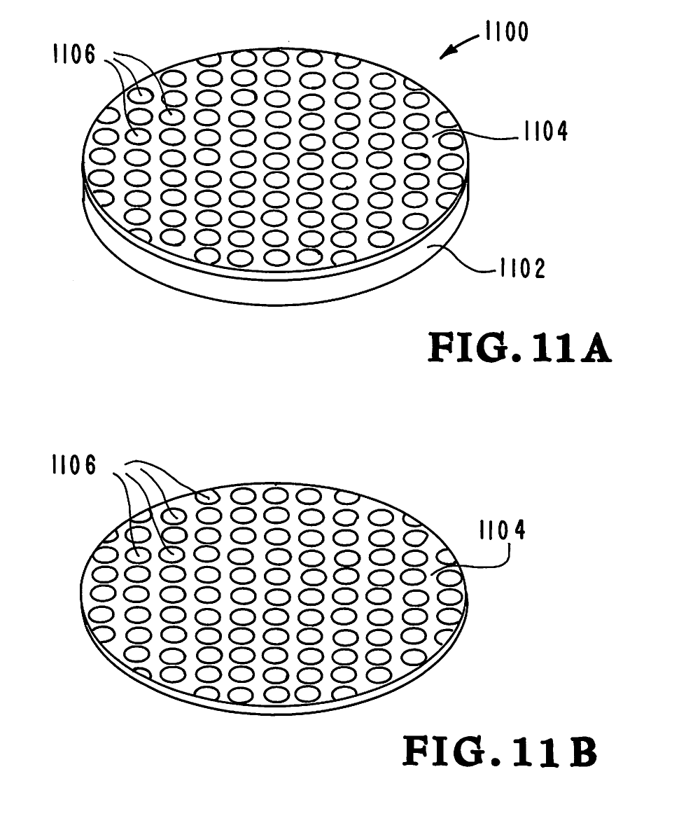

Referring now to FIGS. 11A and 11B, embodiments of nanolithography methods for producing nanoporous filters are illustrated. The nanolithography methods are designated generally by the reference numeral 1100. In one method a nanoporous array is formed on a porous substrate producing a nanoporous filter. In another method, the nanoporous array is removed from the substrate providing a nanoporous filter.

One nanolithography method of producing a nanoporous filter is illustrated in FIG. 11A. A substrate made of a porous material 1102 is provided. A thin layer of metal or other material is applied to the surface of the substrate. The thin layer 1104 will serve as the matrix of the filter. A mask is created on the surface of the thin layer 1104 by combining a first polymer and a second polymer to form a polymer layer (not shown) of the first and second polymer. The first polymer self-assembles into nanodomains of the first polymer in the second polymer. The self-assembly of the nanodomains results in the formation of a uniform hexagonal pattern of the first polymer nanodomains in the second polymer over the surface on the thin layer 1104. The nanodomains are removed by etching to form nano-voids that extend through the polymer layer. Nanopores are created in the thin layer 1104 by ion beam milling the thin layer material through the nano-voids to produce nano-pores 1106 that extend through the thin layer 1104 creating the array 1100 having nanopores 1106. The nanopores 1106 in the thin layer 1104 matrix and the flexible material substrate 1102 provide a nanoporous filter.

Referring to FIG. 11B, another nanolithography method of producing a nanoporous filter is illustrated. The steps of providing a substrate 1102 and coating a thin layer 1104 of metal or other on the surface of the substrate are performed. A mask is created on the thin layer 1104 by combining a first polymer and a second polymer to form a polymer layer (not shown) of the first and second polymer that self-assemble into nanodomains of the first polymer in the second polymer forming a uniform hexagonal pattern of the first polymer nanodomains in the second polymer over the surface on the thin layer 1104. The nanodomains are removed by etching to form nano-voids that extend through the polymer layer. Nanopores are created in the thin layer 1104 by ion beam milling the thin layer material through the nano-voids to produce nano-pores 1106 that extend through the thin layer 1104. The thin layer 1104 matrix with the nanopores 1106 is removed from the substrate 1102 providing a filter.

Although the description above contains many details and specifics, these should not be construed as limiting the scope of the application but as merely providing illustrations of some of the presently preferred embodiments of the apparatus, systems, and methods. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

1. A nanolithography method for creating an array, comprising the steps of:
providing a substrate having surface;
coating a layer of material on said surface of said substrate providing a material surface;
forming a mask on said material surface by combining a first polymer and a second polymer to form self-assembled nanodomains of said first polymer in said second polymer and removing said nanodomains to form nano-voids in said mask; and
ion beam milling said material through said nano-voids in said mask producing nano-pores in said material creating the array.

2. The nanolithography method for creating an array of claim 1 wherein said step of coating a layer of material on said surface of said substrate providing a material surface comprises controlling the coating of a layer of material on said surface of said substrate to produce said material surface that has a roughness in the range of Rrms 6.0 A to Rrms 20 A.

3. The nanolithography method for creating an array of claim 1 wherein said step of coating a layer of material on said surface of said substrate providing a material surface comprises controlling the coating of a layer of material on said surface of said substrate to produce said material surface that has a roughness in the range of Rrms 6.0 A to Rrms 7.0 A.

4. The nanolithography method for creating an array of claim 1 wherein said step of coating a layer of material on said surface of said substrate providing a material surface comprises controlling the coating of a layer of material on said surface of said substrate to produce said material surface that has a roughness of Rrms 6.5 A.

5. The nanolithography method for creating an array of claim 1 wherein said step of coating a layer of material on said surface of said substrate providing a material surface comprises coating a layer of metal on said surface of said substrate providing a metal surface.

6. The nanolithography method for creating an array of claim 5 wherein said metal comprises gold, silver, or aluminum.

7. The nanolithography method for creating an array of claim 1 wherein said step of coating a layer of material on said surface of said substrate providing a material surface comprises coating a layer of flexible metal on said surface of said substrate providing a flexible metal surface.

8. The nanolithography method for creating an array of claim 1 wherein said step of forming a mask on said material surface comprises combining a first polymer and a second polymer to form self-assembled cylindrical nanodomains of said first polymer in said second polymer and removing said cylindrical nanodomains to form cylindrical nano-voids in said mask.

9. The nanolithography method for creating an array of claim 1 wherein said step of forming a mask on said material surface comprises combining a first polymer and a second polymer to form self-assembled cylindrical nanodomains of said first polymer in said second polymer and removing said cylindrical nanodomains to form cylindrical nano-voids in said mask and wherein said step of ion beam milling said material through said nano-voids in said mask comprises ion beam milling said material through said cylindrical nano-voids in said mask.

10. The nanolithography method for creating an array of claim 1 wherein said step of forming a mask on said material surface comprises combining a first polymer and a second polymer to form self-assembled spherical nanodomains of said first polymer in said second polymer and removing said spherical nanodomains to form nano-voids in said mask.

11. The nanolithography method for creating an array of claim 1 wherein said step of combining a first polymer and a second polymer to form self-assembled nanodomains of said first polymer in said second polymer and removing said nanodomains to form nano-voids in said mask comprises combining a first polymer and a second polymer to form self-assembled nanodomains of said first polymer in said second polymer in a hexagonal pattern of said nanodomains of said first polymer in said second polymer and removing said nanodomains to form a hexagonal pattern of said nano-voids in said mask.

12. The nanolithography method for creating an array of claim 11 wherein said step of ion beam milling said material through said nano-voids in said mask comprises ion beam milling said material through said hexagonal pattern of said nano-voids in said mask producing a hexagonal pattern of said nano-pores in said material creating the array.

13. The nanolithography method for creating an array of claim 1 wherein said step of providing a substrate having surface comprises providing a substrate of silicon having a silicon surface.

14. The nanolithography method for creating an array of claim 1 wherein said step of providing a substrate having surface comprises providing a substrate of a porous material having a porous material surface.

15. The nanolithography method for creating an array of claim 1 wherein said step of providing a substrate having surface comprises providing a substrate of a flexible material having a flexible material surface.

16. A nanolithography method for producing a battery, comprising the steps of:
providing an anode substrate having an anode substrate surface,
coating a layer of anode material on said anode substrate surface providing an anode material surface,
forming a mask on said anode material surface by combining a first polymer and a second polymer to form self-assembled nanodomains of said first polymer in said second polymer and removing said nanodomains to form nano-voids in said mask,
ion beam milling said anode material through said nano-voids in said mask producing nano-pores in said anode material creating an anode array of said anode substrate and said anode material with nano-pores,
providing a cathode substrate having a cathode substrate surface,
coating a layer of cathode material on said cathode substrate surface providing a cathode material surface,
forming a mask on said cathode material surface by combining a first polymer and a second polymer to form self-assembled nanodomains of said first polymer in said second polymer and removing said nanodomains to form nano-voids in said mask,
ion beam milling said cathode material through said nano-voids in said mask producing nano-pores in said cathode material creating a cathode array of said cathode substrate and said cathode material with nano-pores,
providing an electrolyte between said anode array and said cathode array,
and connecting a circuit between said anode array and said cathode array producing the battery.

17. The nanolithography method for producing a battery of claim 16 wherein the step of providing an anode substrate comprises providing an anode substrate made of an insulator material and wherein the step of providing a cathode substrate comprises providing an cathode substrate made of an insulator material.

18. A nanolithography method for producing a filter, comprising the steps of:
providing a substrate having a substrate surface,
coating a layer of metal or other material on said substrate surface providing a metal or other material surface,
forming a mask on said metal or other material surface by combining a first polymer and a second polymer to form self-assembled nanodomains of said first polymer in said second polymer and removing said nanodomains to form nano-voids in said mask, and
ion beam milling said metal or other material through said nano-voids in said mask producing nano-pores in said metal or other material creating an array of said porous substrate and said metal or other material with nano-pores to produce said filter.

19. The nanolithography method for producing a filter of claim 18 wherein said step of wherein said step of coating a layer of material on said surface of said substrate providing a metal or other material surface comprises controlling the coating of a layer of metal or other material on said surface of said substrate to produce said metal or other material surface that has a roughness in the range of Rrms 6.0 A to Rrms 20 A.

20. The nanolithography method for producing a filter of claim 18 wherein said step of coating a layer of metal or other material on said surface of said substrate providing a metal or other material surface comprises controlling the coating of a layer of metal or other material on said surface of said substrate to produce said metal or other material surface that has a roughness in the range of Rrms 6.0 A to Rrms 7.0 A.

21. The nanolithography method for producing a filter of claim 18 wherein said step of coating a layer of metal or other material on said surface of said substrate providing a metal or other material surface comprises controlling the coating of a layer of metal or other material on said surface of said substrate to produce said metal or other material surface that has a roughness of Rrms 6.5 A.

22. The nanolithography method for producing a filter of claim 18 wherein said step of forming a mask on said metal or other material surface comprises combining a first polymer and a second polymer to form self-assembled cylindrical nanodomains of said first polymer in said second polymer and removing said cylindrical nanodomains to form cylindrical nano-voids in said mask.

23. The nanolithography method for producing a filter of claim 18 wherein said step of forming a mask on said metal or other material surface comprises combining a first polymer and a second polymer to form self-assembled cylindrical nanodomains of said first polymer in said second polymer and removing said cylindrical nanodomains to form cylindrical nano-voids in said mask and wherein said step of ion beam milling said metal or other material through said nano-voids in said mask comprises ion beam milling said metal or other material through said cylindrical nano-voids in said mask.

24. The nanolithography method for producing a filter of claim 18 wherein said step of combining a first polymer and a second polymer to form self-assembled nanodomains of said first polymer in said second polymer and removing said nanodomains to form nano-voids in said mask comprises combining a first polymer and a second polymer to form self-assembled nanodomains of said first polymer in said second polymer in a hexagonal pattern of said nanodomains of said first polymer in said second polymer and removing said nanodomains to form a hexagonal pattern of said nano-voids in said mask.

25. The nanolithography method for producing a filter of claim 18 wherein said step of ion beam milling said metal or other material through said nano-voids in said mask comprises ion beam milling said metal or other material through said hexagonal pattern of said nano-voids in said mask producing a hexagonal pattern of said nano-pores in said metal or other material creating the array.
